(19) United States
(12) Patent Application Publication
(10) Pub. No.: US 2014/0351945 A1
(43) Pub. Date: Nov. 27, 2014

(54) INFORMATION PROCESSING SYSTEM, INFORMATION PROCESSING APPARATUS, AND RECORDING MEDIUM STORING LICENSE MANAGEMENT PROGRAM

(71) Applicant: Takahiro Aso, Tokyo (JP)

(72) Inventor: Takahiro Aso, Tokyo (JP)

(73) Assignee: Ricoh Company, Ltd., Tokyo (JP)

(21) Appl. No.: 14/279,868

(22) Filed: May 16, 2014

(30) Foreign Application Priority Data
May 27, 2013 (JP) 2013-111051

(51) Int. Cl. G06F 21/10

(52) U.S. Cl. CPC G06F 21/105
USPC 726/26

(57) ABSTRACT

An information processing system includes an operation unit that receives an operation from a user and a main unit that operates based on a request from the operation unit. A device information providing part provides device information of the main unit as device information required for a license registration of an application program to be executed by the operation unit. A license management part performs, after an execution of the application program is requested in the operation unit, a license verification by using the device information of the main unit acquired from the main unit based on license management information of the application program of which a license is registered using the device information.

### CROSS-REFERENCE TO RELATED APPLICATION

The present application is based upon and claims the benefit of priority of Japanese Patent Application No. 2013-111051, filed on May 27, 2013, the entire contents of which are incorporated herein by reference.

### BACKGROUND OF THE INVENTION

1. Field of the Invention

The present invention generally relates to an information processing system, an information processing apparatus and a recording medium storing a license management program.

2. Description of the Related Art

There is known, for example disclosed in Japanese Laid-Open Patent Application No. 2009-301188, a license number management apparatus that enables flexible execution of programs between devices by invalidating and validating predetermined programs within a range of number of given licenses.

In a conventional information processing system, it is considered to make a unit portion as an operation unit, which is used to perform a display operation and a key input operation, to be independent from a main unit in order to prevent a reduction in operation responsiveness even when a large load is applied to the main unit. For example, an operating system independent from that of a main unit may be installed in an operation unit so that the operation unit can operate independently from the main unit.

In a conventional information processing system, there may be a case where a license management is required to restrict an information processing operation of an information management apparatus that can execute an application. Therefore, in such an information processing system requiring a license management, the license management may be performed while associating the information management system with the license to be managed.

However, in the information processing system having an operation unit independent from a main unit, it may be difficult to perform a license management of applications performed in the operation unit even if the license management is performed while associating the main unit of the information management system with the license to be managed.

### SUMMARY OF THE INVENTION

There is provided according to an aspect of the present invention an information processing system including: an operation unit that receives an operation from a user; a main unit that operates based on a request from the operation unit; a device information providing part that provides device information of the main unit as device information required for a license registration of an application program to be executed by the operation unit; and a license management part that performs, after an execution of the application program is requested in the operation unit, a license verification using the device information of the main unit acquired from the main unit based on license management information of the application program of which a license is registered using the device information.

There is provided according to another aspect of the present invention an information processing apparatus including: an operation unit that receives an operation from a user; a main unit that operates based on a request from the operation unit; and a license management part that performs, after an execution of an application program to be executed by the operation unit is requested in the operation unit, a license verification by using device information of the main unit, which is acquired from the main unit as device information required for a license registration of the application program, based on license management information of the application program of which a license is registered using the device information.

There is provided according to a further aspect of the present invention a non-transient computer readable recording medium storing a program for causing an information processing apparatus, which includes an operation unit receiving an operation from a user and a main unit operating based on a request from the operation unit, to serve as a license management part that performs, after an execution of an application program to be executed by the operation unit is requested in the operation unit, a license verification by using device information of the main unit, which is acquired from the main unit as device information required for a license registration of the application program, based on license management information of the application program of which a license is registered using the device information.

Other objects, features and advantages of the present invention will become more apparent from the following detailed description when read in conjunction with the accompanying drawings.

The objects and advantages of the invention will be realized and attained by means of the elements and combinations particularly pointed out in the claims.

It is to be understood that both the foregoing general description and the following detailed description are exemplary and explanatory and not restrictive of the invention.

### BRIEF DESCRIPTION OF THE DRAWINGS

FIG. 1 is a schematic diagram illustrating a configuration of an image processing apparatus according to a first embodiment of the invention;

FIG. 2 is a schematic diagram illustrating a flow of application operation data when an operation unit uses a function of a main unit;

FIG. 3 is a schematic diagram illustrating a configuration of a main unit controller;

FIG. 4 is a schematic diagram illustrating a configuration of an operation unit controller;

FIG. 5 is an outline view of the operation unit;

FIG. 6 is a hardware diagram of a computer;

FIG. 7 is a sequence diagram of a license registration process;

FIG. 8 is a sequence diagram of a license verification process;

FIG. 9 is a sequence diagram of another license verification process;

FIG. 10 is a sequence diagram of a further license verification process;

FIG. 11 is a flowchart of a license verification process performed in a license management part;

FIG. 12 is an illustration of a license management table;

FIG. 13 is a sequence diagram of a license adding process; and

FIG. 14 is an illustration of a license table.

### DETAILED DESCRIPTION OF THE PREFERRED EMBODIMENTS

A description will be given below of an image processing apparatus according to a first embodiment of the invention. The image processing apparatus is an example of an information processing system.

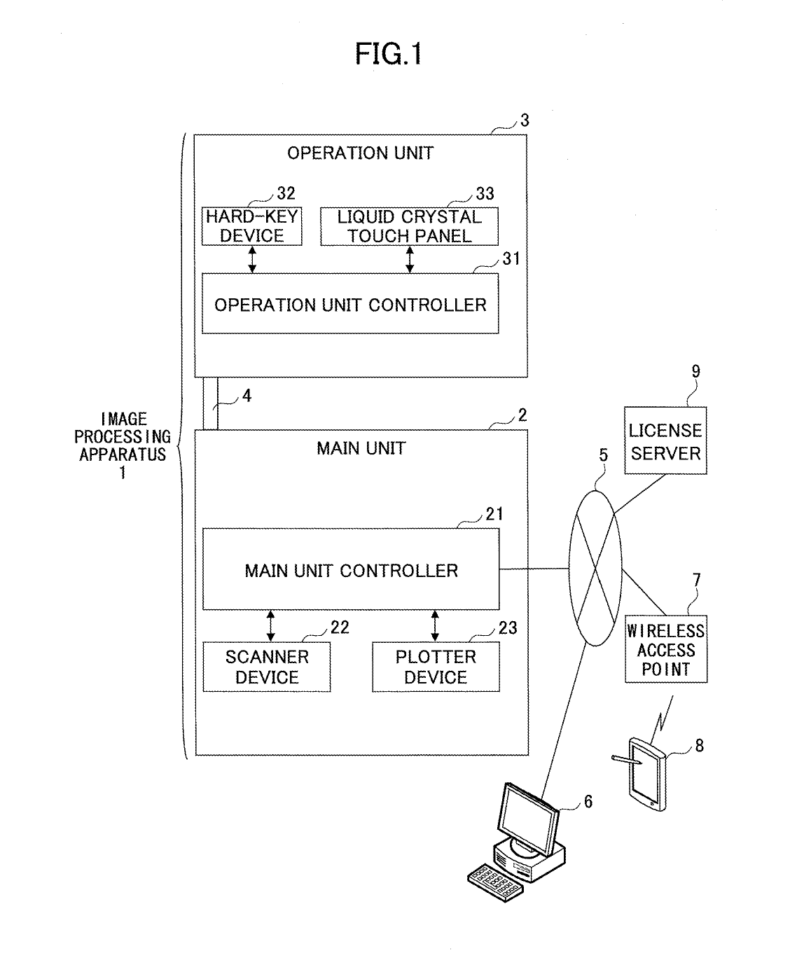

FIG. 1 is a schematic diagram illustrating a configuration of an image processing apparatus 1 according to the first embodiment of the invention. As illustrated in FIG. 1, the image processing apparatus 1 includes a main unit 2 and an operation unit 3 that are communicably connected to each other by a cable 4. The main unit 2 and the operation unit 3 may be connected to each other by a wireless communication line instead of the wired communication line of the cable 4.

The main unit 2 includes a main unit controller 21, a scanner device 22 and a plotter device 23. The main unit controller 21 manages a control operation of the main unit 2. The scanner device 22 performs an operation to read a manuscript. The plotter device 23 performs a printing operation on a print paper.

The main unit 2 may be communicably connected to a terminal device 6, such as a personal computer (PC), and a license server 9 through a network 5 such as a local area network (LAN), a wide area network (WAN) or the Internet so as to be capable of performing data communication. The main unit 2 may also be communicably connected to a terminal device 8, such as a smart phone or a tablet-type information terminal, through a wireless access point 7 connected to the network 5 so as to be capable of performing data communication. The terminal device 8 may be configured to have direct access to the main unit 2 using a short-distance wireless line such as the Bluetooth®.

The operation unit 3 includes an operation unit controller 31, a hard-key device 32 and a liquid crystal touch panel 33. The operation unit controller 31 manages a control operation of the operation unit 3. The hard-key device 32 receives an input operation from a user. The liquid crystal touch panel 33 performs a screen display and receives an operation input.

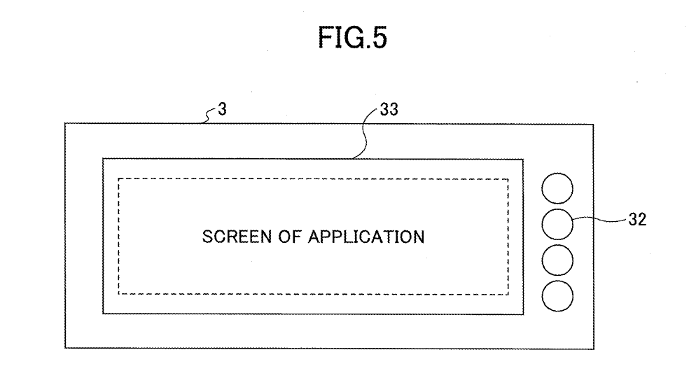

Although illustration is omitted, the operation unit 3 may also be communicably connected to the terminal 6 such as a personal computer (PC) and the license server 9 through the network 5 so as to be capable of performing data communication. The operation unit 3 may also be communicably connected to the terminal device 8 through the wireless access point 7 connected to the network 5 so as to be capable of performing data communication. As mentioned above, the main unit 2 and the operation unit 3 can be connected to the network 5 through a wired connection or a wireless connection. The license server 9 performs operations such as a database management of license information, a downloading operation of an application 316 (refer to FIG. 4) to the image processing apparatus 1, etc.

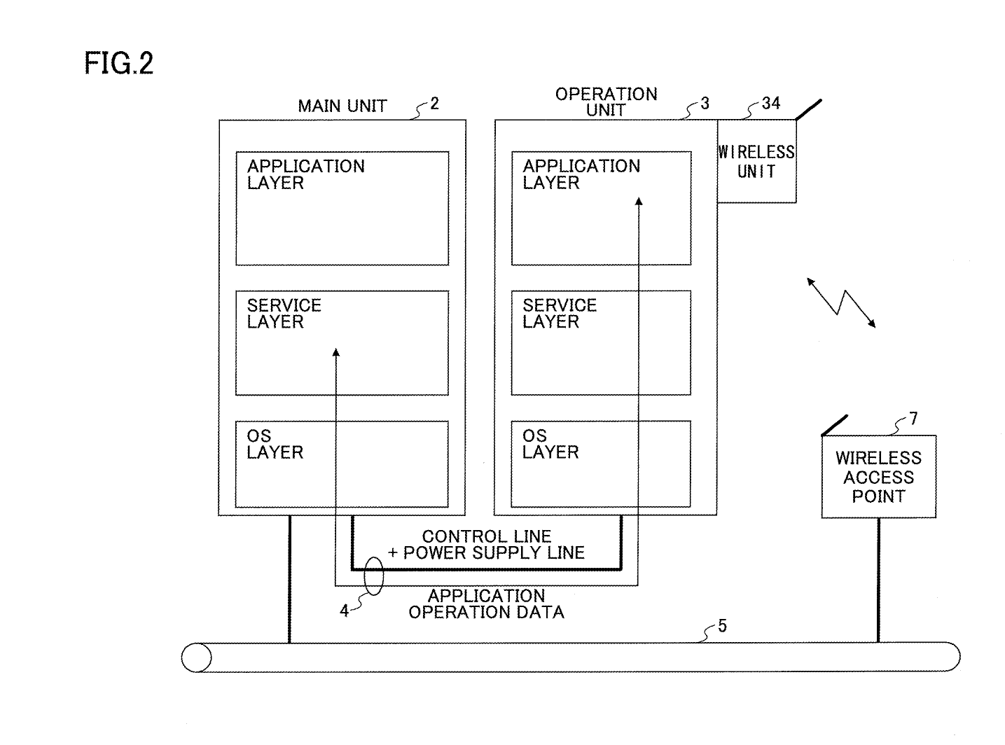

FIG. 2 is a schematic diagram illustrating a flow of application operation data when the operation unit 3 uses a function of the main unit 2. As illustrated in FIG. 2, the cable 4 includes a control line and a power supply line that extend from the main unit 2. The application operation data transmitted from an application layer of the operation unit 3 is transmitted to a service layer of the main unit 2 through the cable 4.

Each of the main unit 2 and the operation unit 3 is divided into layers including an OS layer, a service layer and an application layer. The OS layer is basic software to operate the main unit 2 and the operation unit 3. The OS layer provides basic functions, such as a device control, a process control, a memory control, etc., to upper layers. The service layer provides processes including control services for controlling the main unit 2 and operation unit 3. The control services include a power supply control, a user management, an authentication management, a network management, etc. The application layer provides processes to realize various functions of the image processing apparatus 1, such as a printer function, a scanner function, a facsimile function, etc.

Although FIG. 2 illustrates an example of connecting the main unit 2 to the network 5 by a wired connection, the main unit 2 may be connected to the network 5 by a wireless connection. Moreover, although FIG. 2 illustrates an example of connecting the operation unit 3 to the network 5 by a wireless communication using a wireless unit 34, the operation unit 3 may be connected to the network 5 by a wired communication.

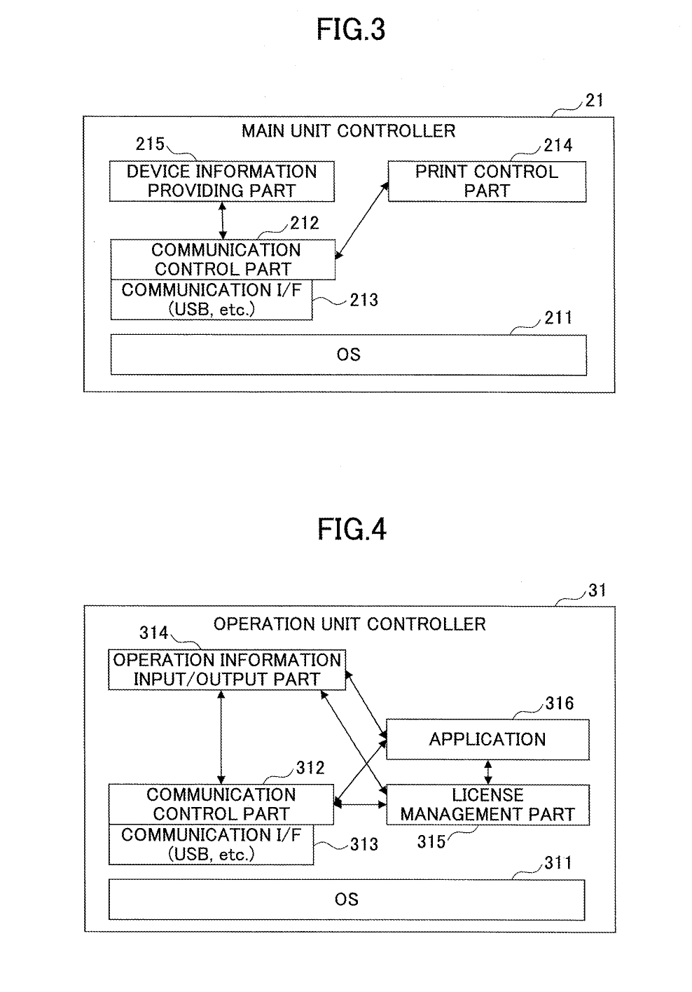

FIG. 3 is a schematic diagram illustrating a configuration of the main unit controller 21 provided in the main unit 2 of the image processing apparatus 1. The main unit controller 21 includes an operating system (OS) 211, a communication control part 212, a communication interface (I/F) 213, a print control part 214 and a device information providing part 215.

The OS 211 is basic software of the main unit controller 21. The communication control part 212 provides a function to control data communication with the operation unit 3 through the communication I/F 213. The communication control part 212 transfers data received from external devices to the print control part 214 and the device information providing part 215. The communication control part 212 also transfers data received from the print control part 214 and the device information providing part 215 to external devices. The communication I/F 213 is a communication device such as a universal serial bus (USB) interface, a serial interface, a wired interface, a wireless local area network (LAN) interface, a Bluetooth® interface, an infrared data association (IrDA) interface, etc.

The print control part 214 provides a function to manage a print job by controlling the scanner device 22, the plotter device 23, etc. The print control part 214 sends a display request of displaying an operation screen to an operation information input/output part 314 (mentioned later) using the communication control part 212. The device information providing part 215 provides device information to a license management part 315 (mentioned later) based on a device information acquisition request sent from the license management part 315.

FIG. 4 is a schematic diagram illustrating a configuration of the operation unit controller 31 provided in the operation unit 3 of the information processing apparatus 1. The operation controller 31 includes an operating system (OS) 311, a communication control part 312, a communication interface (I/F) 313, an operation information input/output part 314, the license management part 315 and the application 316.

The OS 311 is basic software of the operation unit controller 31. Because the operation unit controller 31 is provided with the independent OS 311, the operation unit controller 311 can operates independently from the main unit 2. The OS 311 may be realized by, for example, Android operating system (OS) or the like.

The communication control part 312 provides a function to control data communication with the main unit 2 through the communication I/F 313. The communication control part 312 transfers data received from external devices to the operation information input/output part 314, the license management part 315 and the application 316. The communication control part 312 also transfers data received from the operation information input/output part 314, the license management part 315 and the application 316 to external devices. The communication I/F 313 is a communication device such as a universal serial bus (USB) interface, a serial interface, a wired interface, a wireless local area network (LAN) interface, a Bluetooth® interface, an infrared data association (IrDA) interface, etc.

The operation information input/output part 314 provides a function to display a screen to a user through the liquid crystal touch panel 33. The operation information input/output part 314 also provides a function to receive a user operation through the liquid crystal touch panel 33.

The license management part 315 performs license management regarding the application 316 executed in the operation part 3. The application 316 is an application program such as an image viewer application that is operable on the side of the operation unit 3. The license management will be described later in detail.

FIG. 5 is an outline view of an example of the operation unit 3. As illustrated in FIG. 5, the operation unit 3 is equipped with the hard-key device 32 and the liquid crystal touch panel 33. The hard-key device 32 includes keys to be operated by a user in order to receive a user operation even when the liquid crystal touch panel 33 is off (deactivated). The keys of the hard-key device 32 are assigned to “return”, “display home screen”, “stop”, etc., that are commonly used in each screen displayed on the liquid crystal touch panel 33. The assignment to the keys of the hard-key device 32 can be changed by user customization.

The liquid crystal panel 33 is provided with a display area so that screens provided by the application 316 are displayed within the display area. A user can execute the application 316 or install an additional application through the operation unit 3 as illustrated in FIG. 5.

The main unit 2 and the operation unit 3 may be provided in the same housing, or may be provided in different housings respectively. For example, the operation unit 3 may be detachably provided to a housing of the main unit 2 and be configured to perform wireless communication with the main unit 2 so that the operation unit 3 can be used while being separated and remote from the main unit 2.

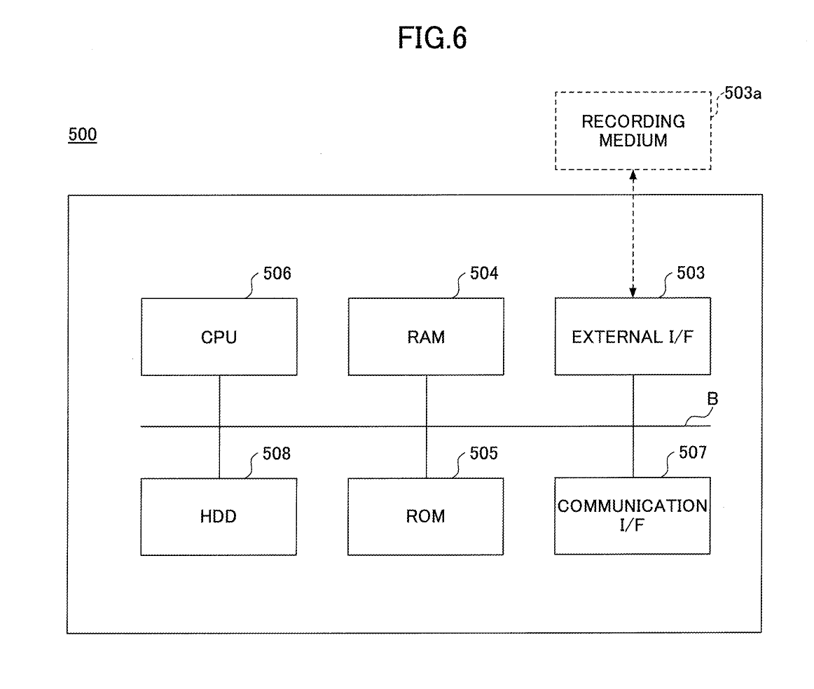

FIG. 6 is a hardware diagram of a computer that may be used as the main unit controller 21 and the operation unit controller 31. The main unit controller 21 illustrated in FIG. 3 and the operation unit controller 31 illustrated in FIG. 4 may be realized by, for example, the computer 500 of the hardware configuration illustrated in FIG. 6.

The computer 500 illustrated in FIG. 6 includes an external interface (I/F) 503, a random access memory (RAM) 504, a read only memory (ROM) 505, a central processing unit 506, a communication interface (I/F) 507 and a hard disk drive (HDD) 508, that are mutually connected through a bus B.

The communication I/F 507 corresponds to the communication I/Fs 213 and 313 mentioned above. The HDD 508 is a nonvolatile storage device for storing programs and data. The programs and data stored in the HDD 508 include an operating system (OS), which is basic software for controlling the entire computer 500, application programs in the application layer that provide various functions on the operation system, and service programs of the service layer that provide various functions on the operation system. The HDD 508 manages the stored programs and data by a predetermined file system and/or a predetermined database (DB).

The external I/F 503 is an interface with external devices. The external devices include a recording medium 503a and the like. The computer 500 is capable of reading and/or writing data on the recording medium 503a through the external I/F 503. The recording medium 503a includes a flexible disk, a compact disk (CD), a digital versatile disk (DVD) a SD memory card, a USB memory, etc.

The ROM 505 is a nonvolatile semiconductor memory (storage device) which is capable of retaining programs and data even when a power supply is turned off. The ROM 505 stores a basic input/output system (BIOS), operating system (OS) setting and network setting that are executed when the computer 500 is turned on (activated). The RAM 504 is a nonvolatile semiconductor memory (storage device) for temporarily retaining programs and data.

The CPU 506 is an operation unit that reads programs and data from the storage devices such as the ROM 505 and HDD 508. The CPU 506 stores the read programs and data on the RAM 504 so as to perform necessary operations to realize controls and functions of the entire computer 500.

The main unit controller 21 and the operation unit controller 31 realize various processes mentioned later by executing programs on the computer 500 of the above-mentioned hardware configuration. The programs may be provided to the computer 500 by any suitable transient or non-transient recording medium such as a flexible disk, a hard disk, a compact disk (CD), a digital versatile disk (DVD) a SD memory card, a USB memory, etc.

A detailed description will now be given of the processes performed by the image processing apparatus 1 according to the first embodiment.

The image processing apparatus 1 performs license management in accordance with a license registration, a license verification and a license addition that are mentioned below.

A description is given below of the license registration.

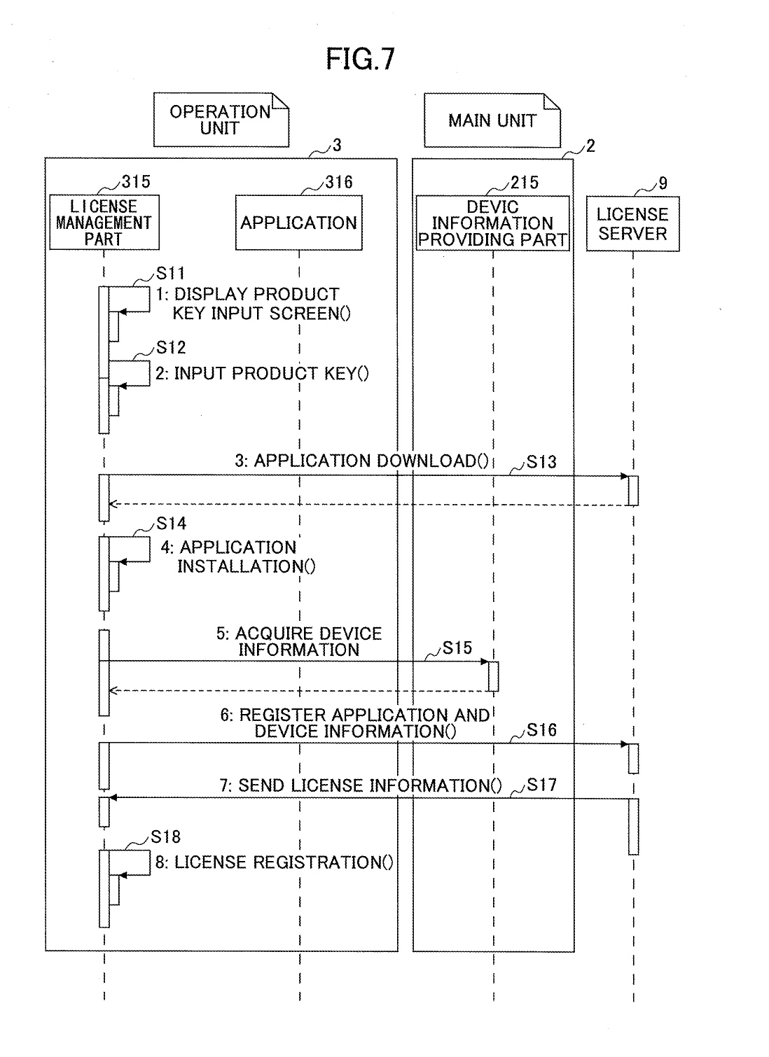

FIG. 7 is a sequence diagram of a process of the license registration performed by the image processing apparatus 1. When adding the application 316 to the operation unit 3, the image processing apparatus 1 performs the license registration as illustrated in the sequence diagram of FIG. 7.

A user (operator) who desires to install the application 316 to the operation unit 3 selects “server installation” from the menu displayed on the liquid crystal touch panel 33 of the operation unit 3. The server installation” corresponds to an operation to download the application 316 from the license server 9 and install the downloaded application 316 in the operation unit 3.

When a user selects the “server installation”, the license management part 315 performs, in step S11, a dialog display of a product key input screen. Then, the user inputs, in step S12, a product key of the application 316, which is an object to be installed, in the product key input screen dialogically displayed on the liquid crystal touch panel 33. The product key corresponds to a license key of the application 316. Normally, a user purchases such a product key for each application 316.

Then, the license management part 315 sends, in step S13, the product key, which is input in the product key input screen, to the license server 9, and downloads the application 316 corresponding to the product key from the license server 9. Although the application 316 is downloaded from the license server 9 in the sequence diagram of FIG. 7, a download server may be provided so that the application 316 is downloaded from the download server.

The license management part 315 installs, in step S14, the application 316, which is downloaded in step S13, in the operation unit 3. The application 316 installed in the operation unit 3 is saved in, for example, the ROM 505 of the operation part 3.

After the application 316 is installed, the license management part 315 issues, in step S15, a request of acquiring device information to the main unit 2 in order to perform an activation process (validation) of the installed application 316. The activation process is a process of enabling an application to be usable by performing an authenticating process to check a possession of normal license of the installed application 316.

The device information mentioned above may include information regarding a serial number ID, information regarding a device model, information regarding services usable in a device, etc. The serial number ID is information that can uniquely identify a device. The information regarding services usable in a device includes information regarding a copy service, a printer service, a scanner service, a facsimile service, etc.

Upon receipt of the acquisition request for the device information sent from the operation unit 3, the device information providing part 215 provides the device information to the license management part 315 of the operation unit 3. Then, the license management part 315 sends, in step S16, information regarding the application 316 acquired from the main part 2 and the device information acquired from the main part 2 to the license server 9. The information regarding the application 316 may be, for example, a name, a product ID, a product key, etc.

The license server 9 determines whether the product key corresponding to the product ID contained in the information regarding the application 316 is effective. If the product key corresponding to the product ID contained in the information regarding the application 316 is effective, the license server 9 registers the product key in a license table and sends, in step S17, the license information to the license management part 315.

Then, the license management part 315 saves, in step S18, the received license information as license management information in a license management table. The license management table will be described later in detail. After the license registration process of FIG. 7 is completed normally, the user is allowed to use the application 316.

A description will be given below of the license verification.

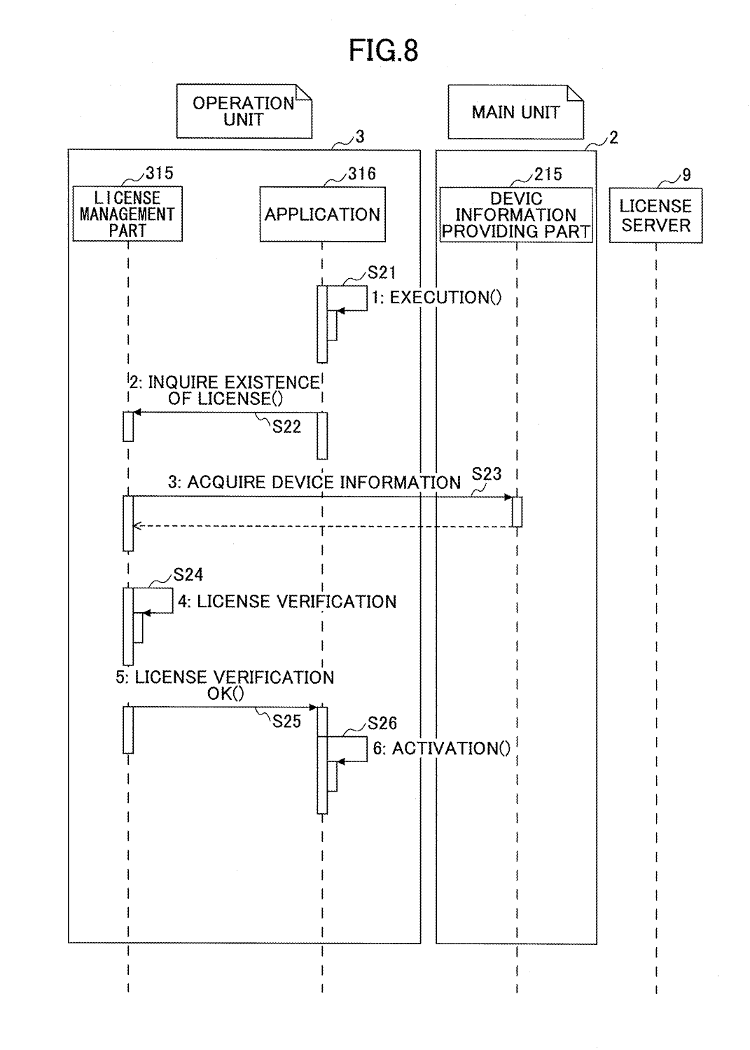

FIG. 8 is a sequence diagram of a license verification process performed by the image processing apparatus 1. When using the application 316 of the operation unit 3, the image processing apparatus 1 performs the license verification as illustrated in FIG. 8.

For example, a user who desires to execute the application 316 selects, in step S21, an execution of the application 316 from a menu displayed on the liquid crystal touch panel 33 of the operation unit 3. When the user selects an execution of the application 316, the application 316 inquires, in step S22, the license management part 315 as to whether a license exists.

Then, the license management part 315 sends, in step S23, a request of acquiring device information to the main unit 2. Upon receipt of the request of acquiring the device information, the device information providing part 215 of the main unit 2 provides the device information to the license management part 315 of the operation unit 3.

The license management part 315 performs, in step S24, a license verification as mentioned below. The license verification is a process of determining whether an activation of the application 316 is permitted before the activation of the application 316 is started. Here, a description is given of an example in which it is determined that the activation of the application 316 is permitted.

If it is determined that the activation of the application 316 is permitted, the license management part 315 sends, in step S25, information indicating license verification OK to the application 316. Upon receipt of the information indicating license verification OK, the application 316 is activated in step S26.

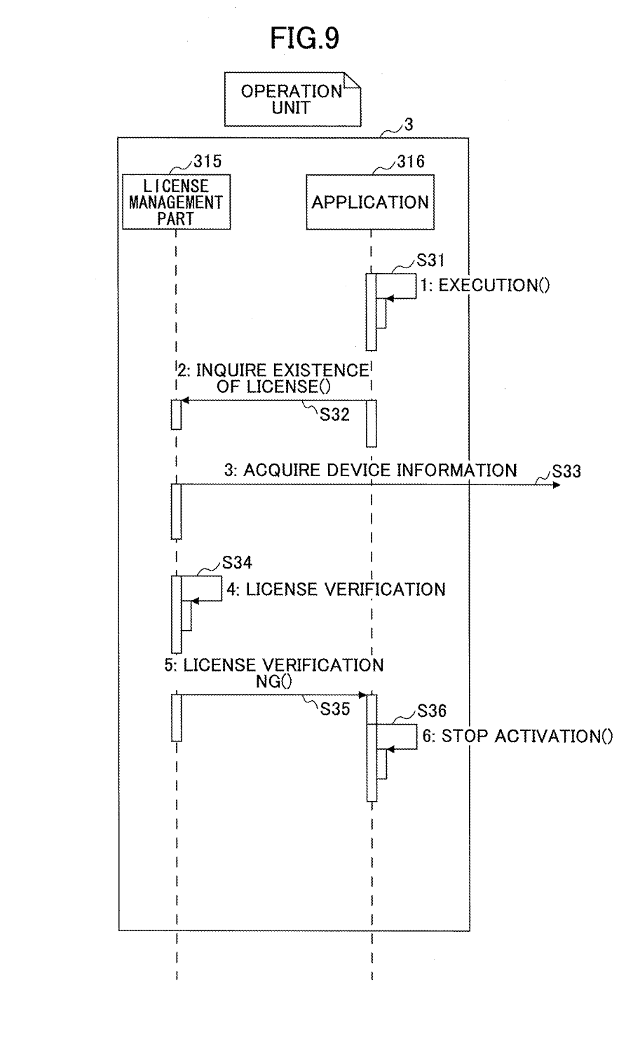

If the operation unit 3 is usable while being detached and separated from the main unit 2 and when the application 316 is executed while the operation unit 3 is detached from the main unit 2, the activation of the application 316 is stopped due to the license verification being performed as illustrated in FIG. 9. FIG. 9 is a sequence diagram of another process of license verification performed in the image processing apparatus 1.

The process of steps S31 to S32 is the same as the process of steps S21 to S22 of FIG. 8, and thus a description thereof will be omitted. The license management part 315 sends, in step S33, a request of acquiring device information to the main unit 2. However, an error occurs in the request process because the operation unit 3 is not connected to the main unit 2 (disconnected state).

The license management part 315 performs, in step S34, a license verification, and determines that the activation of the application 316 is not permitted because the device information cannot be acquired. When it is determined that the activation of the application 316 is not permitted, the license management part 315 sends, in step S35, information indicating license verification NG to the application 316. Upon receipt of the information indicating license verification NG, the application 316 stops, in step S26, the activation of the application 316. At this time, for example, the application 316 may cause the liquid crystal touch panel 33 to display a license authentication error.

According to the license verification process illustrated in FIG. 9, the activation of the application 316 can be stopped if the application 316 is executed while the operation unit 3 is detached and removed from the main unit 2 in which the license is registered.

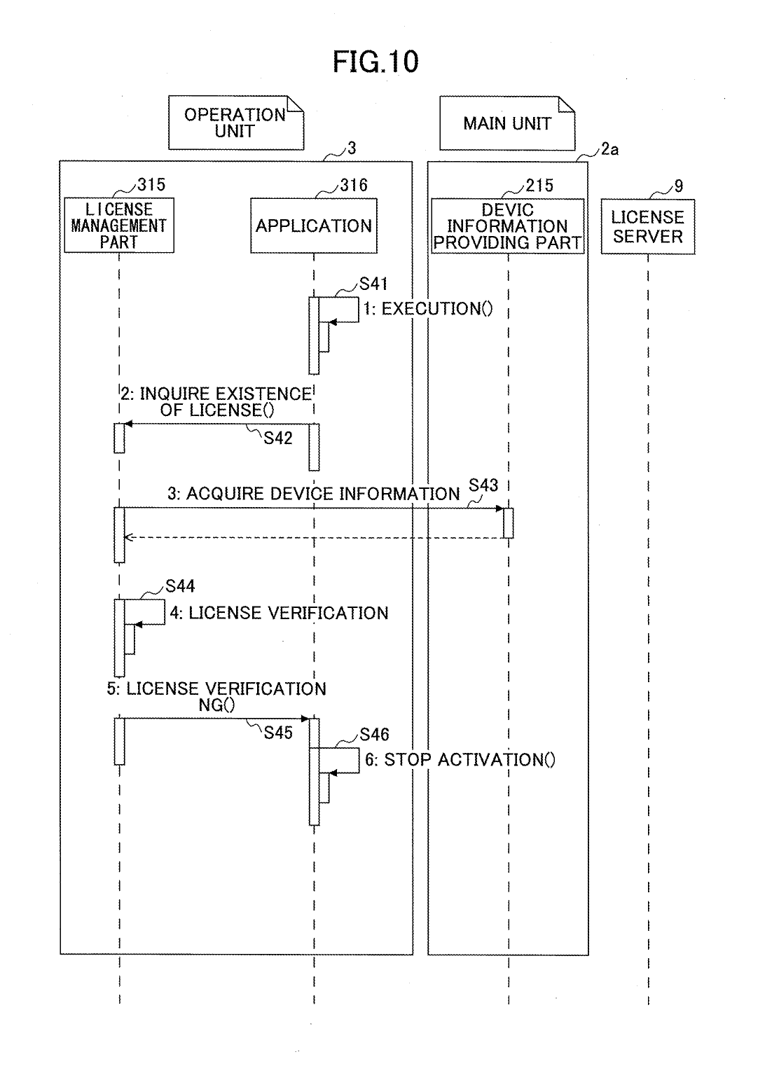

FIG. 10 is a sequence diagram of another process of license verification performed in the image processing apparatus 1. If one attempts to execute the application 316 while the operation unit 3, which is usable while being separated from the main unit 2, is connected to a part other than the main unit 2, an activation of the application 316 is stopped due to the license verification being performed as illustrated in FIG. 10.

The process of steps S41 to S42 is the same as the process of steps S21 to S22 of FIG. 8, and thus a description thereof will be omitted. The license management part 315 sends, in step S43, a request of acquiring device information to a main unit 2a other than the main unit 2 in which the license registration has been performed. The device information providing part 215 of the main unit 2a, to which the acquisition of the device information is requested by the operation unit 3, provides the device information to the license management part 315 of the operation unit 3.

The license management part 315 performs, in step S44, a license verification as mentioned later. Thus, the license management part 315 makes a determination that an activation of the application 316 is not permitted because the device information acquired from the operation unit 3 is different from the license information which has been registered. When it is determined that the activation of the application 316 is not permitted, the license management part 315 sends, in step S45, information indicating license verification NG to the application 316. Upon receipt of the information indicating license verification NG, the application 316 stops, in step S46, the activation of the application 316. At this time, for example, the application 316 may cause the liquid crystal touch panel 33 to display a license authentication error.

According to the license verification process illustrated in FIG. 10, the activation of the application 316 can be stopped if the application 316 is executed while the operation unit 3 is connected to a part other than main unit 2 in which the license registration has been performed. Thus, according to the license verification process illustrated in FIG. 10, the application 316 is prevented from being abused or illegally used without using main unit 2 to which the license registration has been performed.

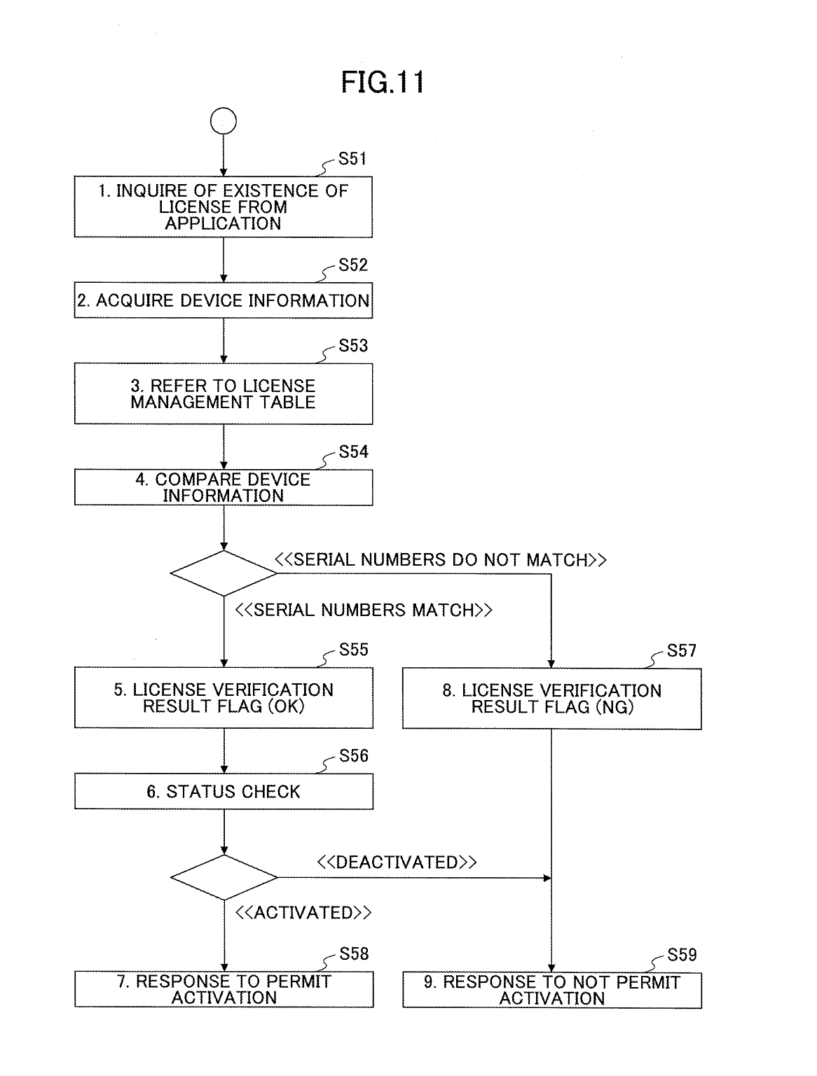

The license verification by the license management part 315 is performed as illustrated in FIG. 11. FIG. 11 is a flowchart of a license verification process performed in the license management part 315.

The license management part 315 receives from the application, in step S51, an inquiry of whether the license exists. The license management part 315 requests, in step S52, acquisition of device information to the main unit 2, and acquires the device information from the main unit 2.

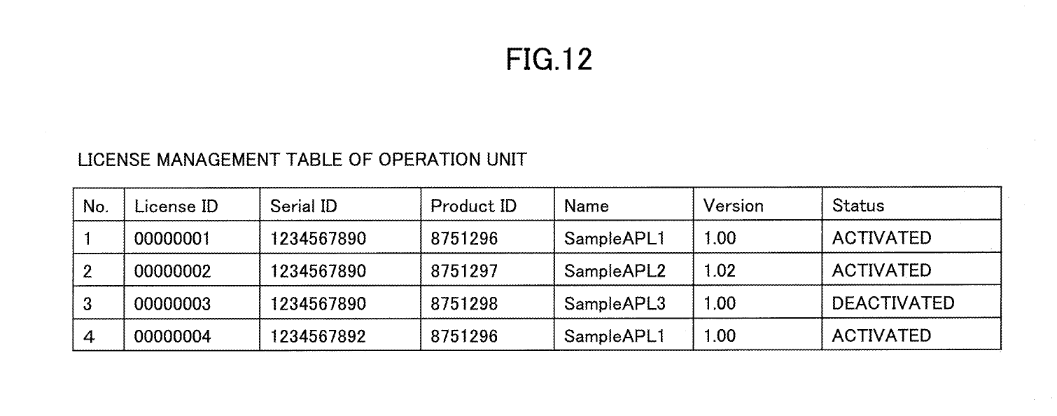

Then, the license management part 315 refers to, in step S53, a license management table. FIG. 12 is an illustration indicating an example of the license management table which the license management table refers to. The license management information retained in the license management table of FIG. 12 includes various data items such as a license ID, a serial ID, a product ID, a name, a version, and a status.

The serial ID is a serial number of the main unit 2 used in the license registration. The product ID is an identification of discriminating the application 316. The name is a designation of the application 316. The version is version information of the application 316. The status is information indicating whether an activation of the application 316 has been made.

Then, the license management part 315 compares, in step S54, whether the serial number ID contained in the device information acquired from the main unit 2 with the serial ID contained in the license management information (the serial number of the main unit 2 at the time of license registration) in order to determine whether the serial number matches the serial ID.

If the serial number matches the serial ID, the license management part 315 causes, in step S55, a license verification result flag to indicate OK. Then, the process proceeds to step S56 in which the license management part 315 determines whether the application 316 has been activated according to the status of the license management information.

If the application 316 has been activated, the license management part 315 determines, in step S58, that the application 316 can be executed, and sends information indicating license verification OK to the application 316.

On the other hand, if it is determined, in step S54, that the serial number ID contained in the device information acquired from the main unit 2 does not match the serial ID contained in the license management information, the license management part 315 performs the process of step S57. That is, in step S57, the license management part 315 causes the license verification result flag to indicate NG. Then, the license management part 315 determines, in step S59, that an activation of the application 316 is not permitted, and sends information indicating license verification NG to the application 316.

Even if it is determined, in step S56, that the application 316 has not been activated, the license management part 315 sends, in step S59, the information indicating license verification NG to the application 316.

As mentioned above, the license management part 315 can prevent the application 316 from being abused or illegally used without using the main unit 2 in which the license registration has been performed, by performing the license verification when activating the application 316.

A description is given below of license addition.

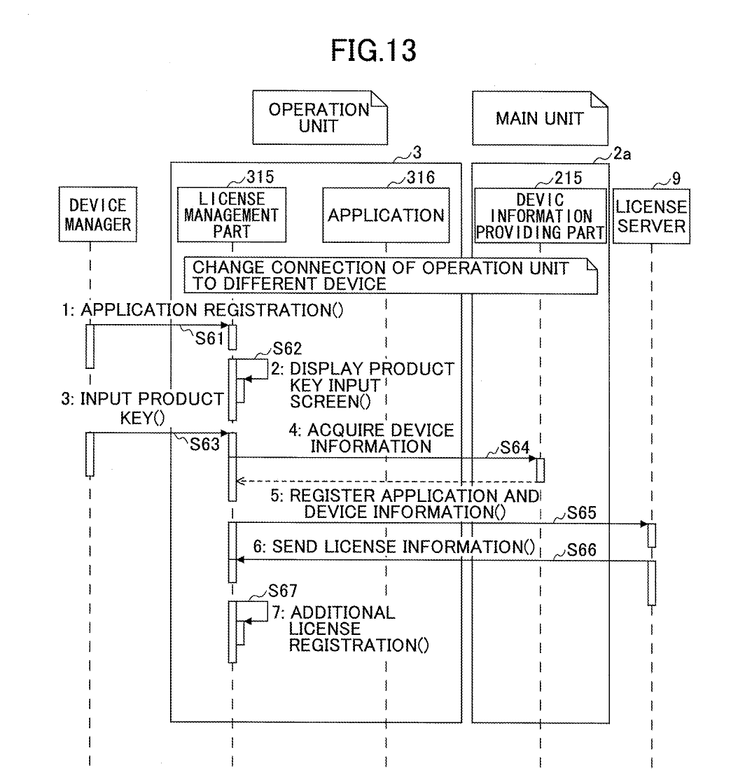

It is considered that the operation unit 3, which can be separated from the main unit 2, is used while the operation unit 3 is connected to a plurality of main units 2. In such a mode of usage, it is desirable to use an application by a plurality of main units 2 to which the operation unit 3 is connected. Thus, the operation unit 3 is configured to permit an addition of a license so that an application can be shared by a plurality of main units 2. FIG. 13 is a sequence diagram illustrating a license addition process performed in the image processing apparatus 1.

It is assumed that after the license registration illustrated in FIG. 7 is completed, the operation unit 3 is detached and removed from the main unit 2 in which the license has been registered, and connected to a main unit 2a other than the main unit 2 in which the license has been registered. If one attempts to execute the application 316 under such a condition, the operation unit 3 stops activating the application 316 in the manner as described with reference to the sequence diagram of FIG. 10.

Thus, the user who is a manager of the image processing apparatus 1 performs an operation to add a license. The user selects, in step S61, a registration of the application 316 from the menu displayed on the liquid crystal touch panel 33.

If the user selects the registration of the application 316, the license management part 315 displays, in step 62, a dialog box of a product key input screen. Then, the user inputs the product key corresponding to the application 316, which is additionally purchased, into the dialog box of the product key input screen.

The license management part 315 performs, in steps S64 to S66, the license registration in the same manner as the process of steps S15 to S17 illustrated in FIG. 7. If the license registration is performed with a different product key, the license server 9 sends, in step S66, license information containing a different license ID to the license management part 315.

The license management part 315 adds, in step S67, the received license information into the license management table of the ROM 505 of the operation unit 3 as license management information so that the application 316 becomes usable when the operation unit 3 is connected to the main unit 2 or 2a.

Additionally, the license management part 315 determines, in step S67, whether to add the license management information to the license management table based on the license ID of the license information sent back from the license server 9. For example, in the license management table illustrated in FIG. 12, the product ID of the license management information of No. 1 is the same as that of No. 4, and the serial ID of No. 1 is different from that of No. 4. That is, the license management information of No. 1 and No. 4 indicates that the application 316 having the product ID of “8751296” is usable by connecting the operation unit 3 to the main unit 2 having the serial number “1234567890” or “1234567892”.

If a product key used in another main unit 2 is input by a user, the license management part 315 does not add the license management information but overwrites the license management information in the license management table. In such a case, the application 316 is not usable even if the operation unit 3 is connected to the another main unit 2. Additionally, if the license ID of the license information provided from the license server 9 already exists in the license management table, the license management part 315 performs overwriting.

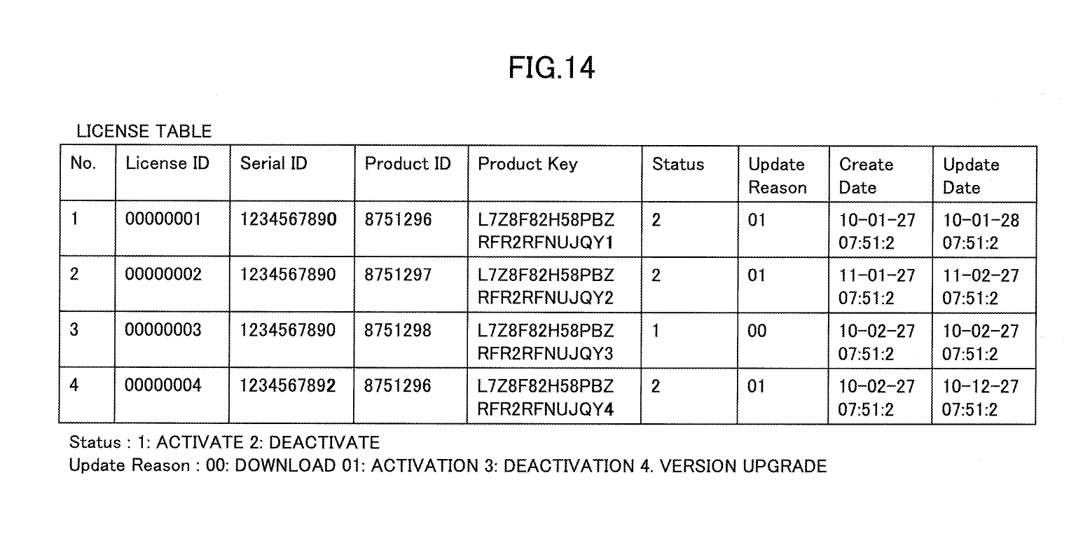

The license server 9 registers the license information in the license table illustrated in FIG. 14. The license table illustrated in FIG. 14 contains data items such as a license ID, a serial ID, a product ID, a product key, a status, an update reason, a create date and an update date.

The license ID, the serial ID, the product ID and the status are the same as those of the license management table illustrated in FIG. 12. The product key is a license key of the application 316 that is input by a user. The update reason indicates a reason for updating the license information. The reason for updating includes download, activation, deactivation, version upgrade, etc. The created date indicates date and time when the license information was created. The update date indicates date and time when the license information was updated.

For example, the license table of FIG. 14 indicates an example where a license registration was made for the applications 316 having the name “SampleAPL1” through “SampleAPL3” (also refer to FIG. 12) in the main unit 2 having the serial ID “1234567890”. Additionally, the license table of FIG. 14 indicates an example where a license addition was made for the application having the name “SampleAPL1” (also refer to FIG. 12) in the main unit 2 having the serial ID “1234567892”.

According to the embodiment described with reference to the image processing apparatus 1, the license management of the application 316, which is operated in the operation unit 3, can be simplified and performed easily by using the device information of the main unit 2. Thus, according to the embodiment described with reference to the image processing apparatus 1, the license management of the application 316, which is operated in the operation unit 3, can be simplified and performed easily even when a serial number ID, which can uniquely identify the operation unit 3, is not usable.

The present invention is not limited to the specifically disclosed embodiments, and various variations and modifications may be made without departing from the scope of the present invention as claimed. For example, the image processing apparatus 1 described above is mere an example of an information processing system, and there are various system configurations according to applications and objects thereof. For example, the license management part 315 may be provided outside the operation unit 3 if it can be operated by the operation unit 3. For example, the license management part 315 may be provided to a server, which is communicable with the operation unit 3, such as the license server 9 or the like. A plurality of license servers 9 may be provided, or the functions of the license server 9 may be dispersed.

The present invention can be implemented in any convenient form, for example, using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can comprise any suitable programmed apparatuses such as a general purpose computer, personal digital assistant (PDA), mobile telephone (such as a WAP or 3G-compliant phone) and so on. Since the present invention can be implemented as software, each and every aspect of the present invention thus encompasses computer software implementable on a programmable device. The computer software can be provided to the programmable device using any conventional carrier medium. The carrier medium can compromise a transient carrier medium such as an electrical, optical, microwave, acoustic or radio frequency signal carrying the computer code. An example of such a transient medium is a TCP/IP signal carrying computer code over an IP network, such as the Internet. The carrier medium can also comprise a storage medium for storing processor readable code such as flexible magnetic disk, hard disc, CD-ROM, magnetic tape device or solid state memory device. The computer software can be provided to the programmable apparatus using any non-transient recording medium for recording processor readable code, such as a flexible magnetic disk, hard disk, CD-ROM, magnetic tape, solid-state memory, etc. The hardware platform encompasses any suitable hardware resources including, for example, a central processing unit (CPU), random access memory (RAM), hard disc drive (HDD), etc. The CPU can be configured by any suitable types and numbers of processors. The RAM can be configured by any suitable volatile or non-volatile memory. The HDD can be configured by any suitable non-volatile memory that can record a large amount of data. The hardware resources may further be equipped with an input device, output device or network device in conformity with the device type. The HDD may be provided outside the apparatus as long as it can be accessed. In such an example, the CPU and RAM like a cache memory of CPU can serve as a physical memory or main memory of the apparatus, whereas the HDD can serve as a secondary memory of the apparatus.

All examples and conditional language provided herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

What is claimed is:

1. An information processing system comprising:
an operation unit that receives an operation from a user;
a main unit that operates based on a request from said operation unit;
a device information providing part that provides device information of said main unit as device information required for a license registration of an application program to be executed by said operation unit; and
a license management part that performs, after an execution of said application program is requested in said operation unit, a license verification by using the device information of said main unit acquired from said main unit based on license management information of said application program of which a license is registered using said device information.

2. The information processing system as claimed in claim 1, wherein said license management part acquires the device information of said main unit, which is caused to be operated based on said request, when performing a license registration of said application program in said operation unit, and said license management part performs the license registration of said application program using the acquired device information of said main unit.

3. The information processing system as claimed in claim 2, wherein after an execution of said application program is requested in said operation part, said license management part acquires the device information of said main unit from said main unit, which is caused to be operated based on said request, and compares the acquired device information with device information of said device unit acquired from said main unit when registering a license contained in said license management information so that said license management unit determines that a result of said license verification is normal when the device information acquired after an execution of said application program is requested matches the device information acquired when registering the license contained in said license management information.

4. The information processing system as claimed in claim 3, wherein said license management unit determines that a result of said license verification is abnormal when the device information acquired after an execution of said application program is requested does not match the device information acquired when registering the license contained in said license management information.

5. The information processing system as claimed in claim 3, wherein after an execution of said application program is requested in said operation unit, said license management unit determines that a result of said license verification is abnormal when the device information is not acquired from said main unit.

6. The information processing system as claimed in claim 4, wherein when said license management part determines that a result of said license verification is abnormal, said license management part stops an activation of said application program.

7. The information processing system as claimed in claim 5, wherein when said license management part determines that a result of said license verification is abnormal, said license management part stops an activation of said application program.

8. The information processing system as claimed in claim 1, wherein said operation unit is provided with an operating system independent from said main unit so that said operation unit operates independently from said main unit.

9. An information processing apparatus comprising:
an operation unit that receives an operation from a user;
a main unit that operates based on a request from said operation unit; and
a license management part that performs, after an execution of an application program to be executed by said operation unit is requested in said operation unit, a license verification by using device information of said main unit, which is acquired from said main unit as device information required for a license registration of said application program, based on license management information of said application program of which a license is registered using said device information.

10. A non-transient computer readable recording medium storing a program for causing an information processing apparatus, which includes an operation unit receiving an operation from a user and a main unit operating based on a request from said operation unit, to serve as a license management part that performs, after an execution of an application program to be executed by said operation unit is requested in said operation unit, a license verification by using device information of said main unit, which is acquired from said main unit as device information required for a license registration of said application program, based on license management information of said application program of which a license is registered using said device information.
